(19) United States
(12) Patent Application Publication
(10) Pub. No.: US 2016/0243636 A1
(43) Pub. Date: Aug. 25, 2016

(54) BRAZING JOINING METHOD OF CNT ASSEMBLIES ON SUBSTRATES USING AN AT LEAST TERNARY BRAZING ALLOY; CORRESPONDING BRAZING MATERIAL AND DEVICE COMPRISING SUCH ASSEMBLY

(71) Applicant: EMPA Eidgenossische Materialprufungs- und Forschungsanstalt, Dubendorf (CH)

(72) Inventors: Remi Longtin, Zurich (CH); Hans Rudolf Elsener, Baar (CH); Christian Leinenbach, Fehraltdorf/ZH (CH); Juan Ramon Sanchez-Valencia, Zurich (CH)

(73) Assignee: EMPA Eidgenossische Materialprufungs- und Forschungsanstalt, Dubendorf (CH)

(21) Appl. No.: 15/025,689

(22) PCT Filed: Sep. 18, 2014
(86) PCT No.: PCT/EP2014/069904

§ 371 Date: Mar. 29, 2016

(30) Foreign Application Priority Data
Sep. 30, 2013 (CH) 01665/13

(51) Int. Cl. B23K 1/00; H01R 13/03; B23K 35/30; H01J 35/06; B23K 1/19; B23K 35/02

(52) U.S. Cl. CPC B23K 1/0008; B23K 1/19; B23K 35/0244; B23K 35/302; B23K 35/3006; H01J 35/065; H01R 13/03; B23K 2201/36

(57) ABSTRACT

The present application describes a joining method of a Carbon Nanotube-assembly (1) on a substrate (2), showing a reproducible controlled joining with partly carbidization of the carbon nanotubes. To solve this problem, the Carbon Nanotube-assembly (1) is fixed to the substrate (2) by an active brazing process, with the steps of: melting and subsequent wetting and spreading of an active brazing alloy (3) in form of a at least ternary alloy, comprising an amount of copper and at least one carbide forming element with an amount of at least 1 wt % onto the substrate (2), contacting of the Carbon Nanotube-assembly (1) with the active brazing alloy (3) on the substrate (2), followed by a heating step of the components (1, 2, 3) in vacuum or inert gas atmosphere to temperatures above the solidus temperature of the active brazing alloy (3) and between 800° C. and 900° C. corresponding brazing material and assembly are also claimed.

### TECHNICAL FIELD

The present invention describes a joining method of a Carbon Nanotube-assembly on a substrate, an active brazing alloy for joining a Carbon Nanotube-assembly on a substrate, the use of an active brazing alloy for the method and a device comprising a Carbon nanotube-assembly fixed to a substrate.

### STATE OF THE ART

In the early 1990s carbon nanotubes (CNT) were discovered, showing excellent thermal and electrical conduction properties, an inherent high aspect ratio, as well as a high chemical stability. This makes CNTs or assemblies thereof useful in several applications: electron field emission, heat sinks, thermal interface materials, electrical contacts, sliding electrical contacts, soft electrical contacts, actuating contacts and other.

The technical problem so far is the joining of CNT assemblies to any desired substrates. It was tried to use solder techniques borrowed from the electronic industry.

If solder techniques with conventional and commercially available solder alloys are used, the achievable joints of CNTs/CNTs assemblies and substrates are poor in terms of mechanical properties and electron and heat conduction properties. The used low melting point solders based on In and Sn in particular and the soldering technique are well known, working per definition in the temperature range below 450° C.

In most instances, a metallization layer is applied on the nanotubes prior to soldering so as to improve wetting. Unless the metallization layer forms a chemical reaction with the CNTs, these joints remain mechanically and electrically weak resulting in possible delamination at the CNT/metallization interface. Thus, any device based on soldered CNTs can fail during operation due to resistive heating or due to the ambient environment.

Beside the unsatisfactory mechanical and thermal properties of the solder joints of CNT assemblies and substrate, the preceding deposition of additional layers is necessary which is disadvantageous.

Another document using solder alloys with low melting points is EP989579. The metal solder comprising at least one element selected from the group consisting of Sn, In, Bi, and Pb is brought onto a defined substrate, that comprises at least one material selected from the group consisting of carbon-dissolving elements, carbide-forming elements, and low melting point materials. After disposing carbon nanotubes on the specific substrate a heating step is carried out. If the melting of at least a portion of the low melting point materials and a chemical reaction of at least a portion of the nanotubes with carbide-forming elements is achieved, solder joints are the result.

With the so far known methods it is not clear how carbidization could be controlled leading to reproducible performance of only partly formation of carbides of the carbon atoms of the nanotubes. The controlled carbidization is very important for not influencing the desired properties of the carbon nanotubes negatively too much.

In the literature also a brazing technique in vacuum is mentioned for achievement of joints of CNT assemblies and substrates. For example in Wu, W.; Hu, A.; Li, X.; Wei, J. Q.; Shu, Q.; Wang, K. L.; Yavuz, M.; Zhou, Y. N. Vacuum Brazing of Carbon Nanotube Bundles. Mater. Lett. 2008, 62, 4486-4488, different commercial available silver and copper containing braze alloys have been applied to bond bundles of general not aligned carbon nanotube films to substrates. As stated also an additional metal layer, here a niobium metallization layer was needed to reach the joint of CNT layers or films on the substrate.

As stated in JP2000281458, the substrate and the carbon nanotube are bonded through a brazing material wetting and rising up into the tube by the capillary phenomenon. The brazing material is preferably an eutectic alloy system of Fe, Ni and Co containing a group 4a transition metal or a lanthanoid metal, and other group 3d transition metal. The so achieved joints are showing improper mechanical bonding and not satisfying conducting properties, wherefore also this described method is disadvantageous.

In JP4660759 a solid solution bonding with an additional amount of titanium was used, leading to carbide TiC formed between the carbon nanotube and the substrate. The problem of using carbide forming elements using the known methods results in a strong and often uncontrolled carbidization of the CNTs, so that the CNTs are losing their excellent thermal and electrical conduction properties as well as their mechanical strength. From the prior art it is not known, how a controlled reproducible partially performed carbide forming can be achieved.

### DESCRIPTION OF THE INVENTION

The object of the present invention is to create a reliable joining method of vertically aligned CNT assemblies on substrates, in particular metal or metalized substrates, showing a reproducible controlled joining with partly carbidization of the carbon nanotubes, which enables the fabrication of devices showing high thermal and electron conduction as well as high mechanical strength, where the joint respectively the device additionally withstands high temperatures.

The joining method should be benign in that it should not lead to oxidation of the nanotubes, resulting in oxidative damage, or surface oxidation of the substrate, thwarting alloy wetting or joining entirely.

### BRIEF DESCRIPTION OF THE DRAWINGS

A preferred exemplary embodiment of the subject matter of the invention is described below in conjunction with the attached drawings.

FIG. 1a) shows an SEM image of a multiwalled carbon nanotube film on silicon prior to brazing,

FIG. 1b) shows a high magnification HeIM image of the CNTs in the CNT film of FIG. 1a), while

FIG. 1c) shows an optical microscope image of CNT film brazed to a titanium substrate and

FIG. 1d) shows an optical microscope image of CNT film brazed to a Ni-metalized Ti (Ti/Ni) substrate at 880° C. with a Cu—Sn—Ti—Zr active brazing alloy.

FIG. 2 shows a side view SEM image of the CNT film after active brazing on a titanium substrate with Cu—Sn—Ti—Zr fillet with labeled regions.

FIG. 3a) shows a SEM image of a CNT film brazed to Ti with a Ag—Cu—Ti alloy in a perspective view, while

FIG. 3b) depicts a side view SEM image of the fillet of FIG. 3a) in more detail, showing the metal matrix composite region, the diffusion zone and the aligned CNTs.

### DESCRIPTION

One of the main challenges still limiting the application potential of carbon nanotube (CNT) assemblies, for example CNT films is the lack of an appropriate joining methodology that allows the nanotubes to be permanently transferred to relevant substrates leading to conductive, high-temperature resistant and mechanically robust contacts. Such contacts are required for emerging and long-term potential nanotube applications such as high-current electrical interconnects, power transmission cables and thermal management in high-power applications.

The here described active brazing joints have high re-melting temperatures up to the solidus temperatures of the used active brazing alloys, far greater than what is achievable with standard solders, thus expanding the application potential of CNT films to high-current and high-power applications where substantial frictional or resistive heating is expected.

Active brazing involves the melting, wetting and spreading of an active brazing alloy (or filler alloy) into a gap between two work pieces, here a CNT film and a substrate unifying the two upon solidification. Above mentioned soldering is a subset of brazing wherein the filler alloys have liquidus temperatures below 450° C.

To avoid fully converting the nanotubes into carbide particles or dissolved atom carbon, the temperatures here used during the active brazing step were low, between 800° C. and 900° C., in comparison with known brazing processes.

If the active brazing is carried out at temperatures above the solidus but below the liquidus temperatures of the active brazing alloy, the melting of the active brazing alloy is incomplete in the here used heating temperature range. In the gap between the solidus and liquidus temperature, the active brazing alloy consists of a mixture of solid and liquid phases, what leads to desired results. But beside the optimum temperature range the composition of alloy elements, the particle sizes and the binder, which is a cellulose nitrate binder (6.5 wt % CN incl. 35 wt. % iso-propanol) dissolved in 99+% octyl acetate, are essential.

We describe how macroscopic films of vertically aligned multiwall carbon nanotubes can be transferred and joined to titanium respectively nickel metalized titanium substrates by active brazing. The

Active brazing at 820° C. and 880° C. is demonstrated with ternary Ag—Cu—Ti and quaternary Cu—Sn—Ti—Zr brazing alloys, respectively. The applied method also works with single wall carbon nanotubes.

The excellent wetting and spreading of the metal alloys inside the CNT films is attributed to the used binder of the active brazing alloy and the formation of a TiC interphase leading to strong chemical bonding and superior nanotube/substrate contacts with low electrical and thermal resistances. In particular, the electron field-emission performance of the brazed CNT film is excellent and is directly related to improved interfacial electron and heat transport.

### Description of the Figures

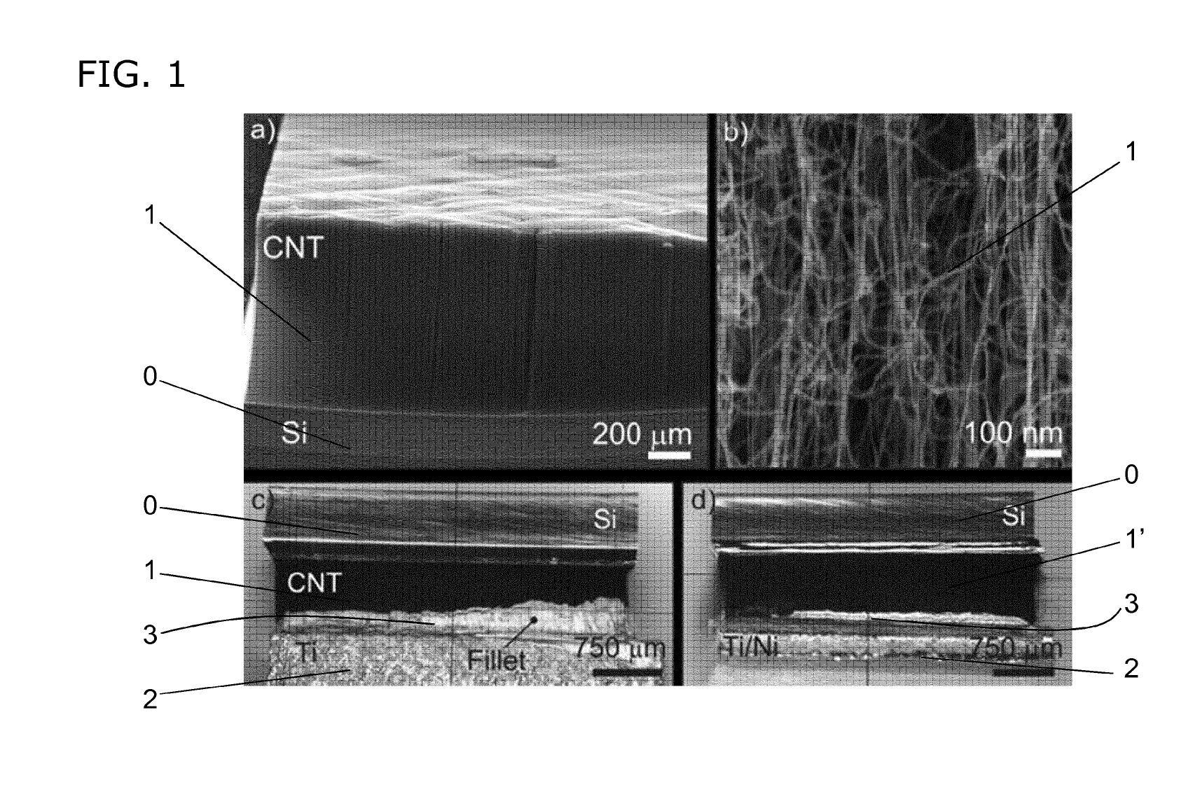

A typical multiwalled nanotube film 1 grown on a growth substrate 0 of silicon is shown in FIG. 1a. Density is 10¹⁰-10¹¹ nanotubes/cm² with this type of growth substrate 0. The vermicular nanotube diameters range from 2-20 nm as seen by helium ion microscopy (HeIM) in FIG. 1b. Two representative CNT films 1, 1′ brazed to Ti and Ti/Ni substrates 2 with the active brazing alloy 3 in form of a Cu—Sn—Ti—Zr alloy 3 at 880° C. are shown in FIGS. 1c and d, respectively. In both cases, the braze alloy has formed a fillet along the film's edge which is indicative of a chemical reaction leading to wetting.

The silicon growth substrate 0 is lifted off after finishing the active brazing process, leading to the transfer and separation of the CNT film from the growth substrate 0 to the substrate 2.

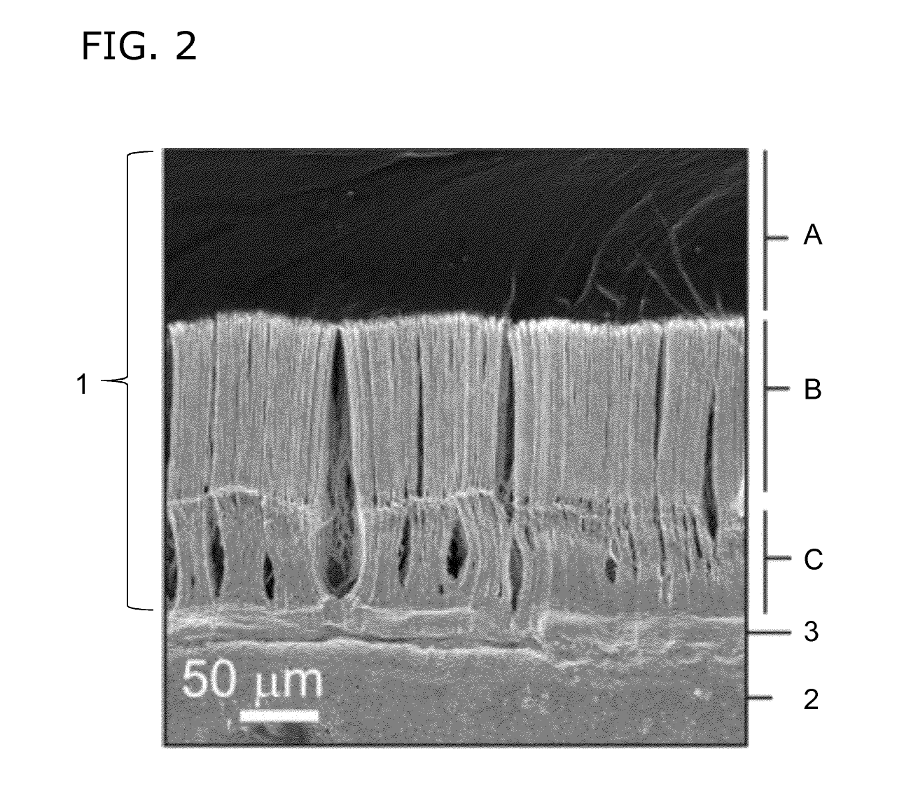

An SEM image of the fillet is shown in FIG. 2. Three distinct regions are labeled. The top A of the film 1 consists of aligned nanotubes. Region B contains metal-coated nanotube bundles while the region C closest to the brazing alloy 3 layer is characterized by larger bundles completely encased in metal; hereafter referred to as the metal matrix carbon nanotube composite region C. The partially melted brazed layer is seen below this region and above the substrate 2.

Brazing is usually carried out above the liquidus temperature of the active brazing alloy 3 at 925° C., however preliminary experiments have shown that this active brazing alloy 3, when it is fully liquid, excessively penetrates the nanotube film 1 and reacts with the Si growth substrate 0 preventing lift-off.

At 880° C., 90% of the active brazing alloy 3 is liquid which is sufficient for joining while limiting the infiltration into the CNT film 1 to the first ˜100 μm. The molten active brazing alloy 3 infiltrated the lower portion of the CNT film 1 by capillarity. It is evident that the improved wetting of the nanotubes in region B is due to the formation of a carbide interphase between the active brazing alloy 3 and the outer nanotube walls.

Overall, the CNT film 1 active brazing process with the Cu—Sn—Ti—Zr alloy 3 can be described as follows: As the temperature is progressively raised to several hundred degrees Celsius, the binder reduces oxide layers on the surfaces of the active brazing alloy and the substrate by in-situ reduction, before a solid state diffusion of Ti towards the carbon nanotubes 1 will occur followed by the formation of a carbide interphase (CNT/TiC). The active brazing alloy 3 will begin to melt as the temperature is raised above its solidus temperature of 868° C. The resulting Cu-rich liquid will wet the nanotubes 1 (CNT/TiC/braze) and will spread laterally leading to bundling as it invades the CNT film 1. Solidification close to the substrate will lead to the formation of the metal matrix composite C. The metal atoms that have diffused on the surface of the nanotube walls from the braze layer into region A will eventually coalesce into nanoparticles.

No significant difference, apart from fillet height, was remarked when brazing CNTs to the bare titanium and Ni-metalized titanium substrates with this quaternary active brazing alloy 3, comprising Cu, Sn, Ti and Zr.

A second active brazing alloy 3′, comprising Ag—Cu—Ti, containing only 1.75 wt. % of Ti was used to join nanotube films 1 to Ti and Ti/Ni substrates 2 at 820° C., that is, above the liquidus temperature of this active brazing alloy 3′. For low Ti-contents, an easily decomposing binder with reducing properties is preferably used.

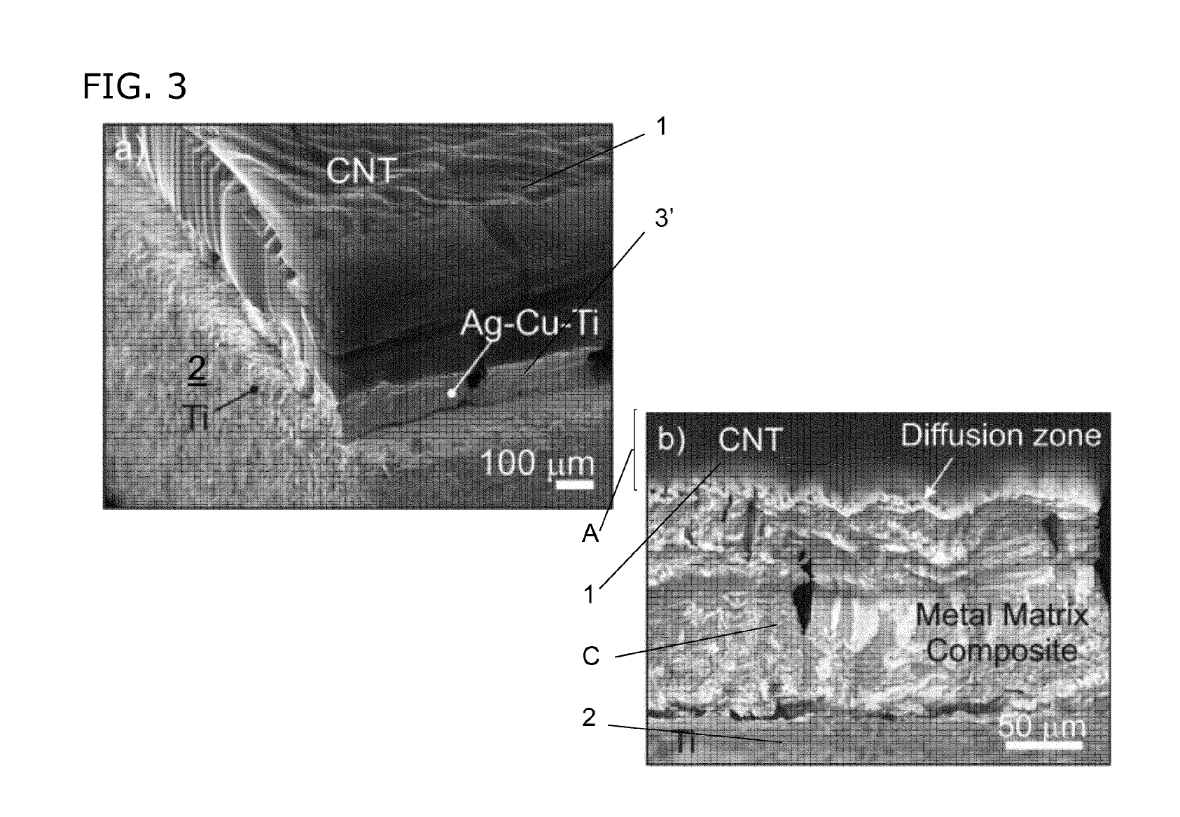

A typical CNT film 1 brazed to Ti after silicon lift-off is shown in FIG. 3a). A fillet is seen on the edge of the nanotube film similarly to what was observed for the Cu—Sn—Ti—Zr braze, however the metal matrix composite region C is now separated from the top CNT region by a thin diffusion zone as shown in FIG. 3b).

Again, the bare CNTs 1 in region A were removed mechanically and revealed extensive bundling leading to a porosity of ˜48%. A high magnification HeIM image of the top of one of the metal matrix C bundles reveals individual metal-sheathed nanotubes protruding from the matrix C. Evidently, the CNTs were not fully converted to TiC here. This is due to the reduced Ti content and lower brazing temperature. Slight microstructural differences are observed when brazing CNTs on Ti/Ni. The fillet height is reduced and bundling is less pronounced with the metalized substrate. Furthermore, a region of a few micrometers in length with metal-coated bundles is now seen below the diffusion zone.

Overall, both alloys 3, 3′ can be used to join CNT films 1 to titanium substrates 2. The joint properties were measured to confirm the applicability of such assemblies. The here described brazing process produces robust joints due to the excellent wetting and the infiltration of active brazing alloys 3 inside the CNT film 1. The active brazing alloy 3 comprises at least one carbide forming element, for example titanium, zirconium, niobium, hafnium, vanadium or chromium, making nanotube metallization prior to the active brazing process unnecessary. Overall, the process described expands the application potential of CNT films 1 to high-current and high-power applications where substantial frictional or resistive heating is expected.

Active brazing in vacuum has the advantage of preserving the excellent physical properties of the nanotubes while permitting their bonding to reactive substrates by limiting both carbon nanotube and substrate oxidation. The active brazing can be carried out in a vacuum with a pressure of below or equal 10⁻² mbar, in particular in a vacuum furnace. The added benefit is that active brazing in vacuum also constitutes a vacuum annealing step that improves the structural ordering of the nanotubes. Since joining is done in vacuum above 800° C., the absence of oxygen preserves the properties of the nanotubes while permitting their bonding to oxygen-reactive substrates such as copper and titanium either bare or metalized.

The as-grown nanotube films 1 were brazed facedown to 4×4×0.6 mm3 Ni-metalized grade 2 titanium (Ti/Ni 2 μm) and to 4×4×0.95 mm3 grade 2 titanium substrates 2 in a vacuum furnace (Cambridge Vacuum Engineering) at 10⁻⁶ mbar. The heating rate was 10° C./min, the dwell time was 5 minutes and the dwell temperature:
I) was 880° C. with 60 μm-thick foils of active brazing alloy 3, having a composition of Cu 73.9-Sn 14.4-Ti 10.2-Zr 1.5 wt. % and
II) was 820° C. when using 100 μm-thick foils of active brazing alloy 3′, having a composition of Ag 63.25-Cu 35-Ti 1.75 wt. %.

The copper alloy 3 has a solidus temperature of 868° C. and a liquidus temperature of 925° C., while the solidus and liquidus temperatures for the silver alloy 3′ are 780° C. and 815° C., respectively.

The used active brazing alloys were formed as brazing foils, made by mixing a metal alloy powder (325 mesh: particle size <44 μm) with an organic binder. Experiments showed, that the particle size is later influencing the wetting of the carbon nanotubes with the active brazing alloy. The resulting paste was manually printed on a flat surface, dried in air and compressed into a brazing foil to the desired thickness. The brazing foil, substrate and inverted CNT film are assembled in a jig and held in place with an adjustable screw during brazing.

Once the brazing step was completed, the Si substrate was removed with tweezers. For inspection, the joints were manually cleaved transversely and longitudinally with a steel blade.

As experiments showed, the active brazing can also be done in an inert gas atmosphere such as argon, leading also to desired results.

The used Carbon Nanotube Films 1 of vertically aligned multiwalled carbon nanotubes were synthesized from C2H2 and H2 by low-pressure chemical vapor deposition in a commercial reactor (Black Magic 2″, AIXTRON) at 695° C. for 20 minutes with a sputtered 2 nm

Fe catalyst film on a 10 nm Al2O3 support layer on a high resistivity boron-doped <100> silicon substrate diced into 4×4×0.75 mm3 pieces.

The device comprising active brazing joints produced by the described method can be used in the fields of field emission and thermal management.

One application that would clearly benefit from Carbon nanotube assemblies joint as described here, showing low electrical and low thermal resistance contacts is carbon nanotube cold electron sources. It was recently demonstrated how thermionic electron sources in commercial X-ray tubes can be replaced by carbon nanotube-based cathodes to produce X-rays without requiring any further modification to the device design. Other applications in which brazed Carbon nanotube assemblies are favourable are wear resistant sliding contacts or heat sinks.

As further experiments showed, the active brazing of the CNT film worked on metallized Silicone and Molybdenum as well.

### LIST OF REFERENCE NUMERALS

0 growth substrate
1 CNT film/Carbon nanotube assembly (multi- or singlewalled nanotubes)
2 substrate (Ti and Ti/Ni substrate)
3, 3′ active brazing alloy
A top of the film
B region with bundles
C matrix

1. Joining method of a Carbon Nanotube-assembly on a substrate using an active brazing alloy in form of an at least ternary alloy, comprising an amount of copper and at least one carbide forming element with an amount of at least 1 wt. %, wherein
the Carbon Nanotube-assembly is fixed to the substrate by an active brazing process, comprising:
at least partial melting and subsequent wetting of the substrate by and spreading of an active brazing alloy in form of the at least ternary alloy, comprising the amount of at least 20 wt. % of copper and an organic binder, whereas the active brazing alloy having a solidus temperature above 770° C., onto the substrate, while heating in vacuum or inert gas atmosphere to temperatures above the solidus temperature of the active brazing alloy and between 800° C. and 900° C., while the Carbon Nanotube-assembly is contacted before, simultaneous or after heating with the active brazing alloy on the substrate.

2. Method according to claim 1, wherein the organic binder is a cellulose nitrate binder.

3. Method according to claim 1, wherein the heating step of the contacted Carbon Nanotube-assembly with the active brazing alloy on the substrate is performed above the solidus temperature and below the liquidus temperature of the active brazing alloy, so as to avoid fully converting the nanotubes into carbide particles or dissolved carbon.

4. Method according to claim 1, wherein the heating step of the contacted Carbon Nanotube-assembly with the active brazing alloy on the substrate is performed at temperatures between 820° C. and 880° C. for 5 minutes to 3 hours, preferably 5-30 minutes.

5. Method according to one of the preceding claims claim 1, wherein the active brazing alloy is an at least quaternary alloy comprising amounts of copper, tin and both carbide forming elements titanium and zirconium mixed with an organic binder.

6. Method according to claim 5, wherein the brazing alloy comprises
between 70-75 wt. % copper,
between 10-15 wt. % tin,
between 5-18 wt. % titanium and
between 0.1-2 wt. % zirconium.

7. Method according to claim 4, wherein the active brazing alloy is a ternary alloy comprising amounts of copper, silver and an amount of a carbide forming element between 1 wt. % and 5 wt. % mixed with an organic binder.

8. Method according to claim 7, wherein the brazing alloy comprises
between 50-70 wt. % silver,
between 20-40 wt. % copper,
between 0.5-2 wt. % titanium and
between 0-25 wt. % indium.

9. Method according to claim 1, wherein particle sizes of the used metallic components in form of a powder of the brazing alloy below 50 μm were used.

10. Method according to claim 1, wherein the brazing alloy is prepared by printing on a surface, drying in air and compressing into a foil with a thickness of between 20 μm and 100 μm prior the active brazing process.

11. Method according to claim 1, wherein the active brazing is carried out in vacuum with a pressure of below or equal 10⁻² mbar, which additionally improves the structural ordering of the nanotubes.

12. Method according to claim 1, wherein the active brazing is carried out in an inert gas atmosphere, for example argon.

13. Method according to claim 1, wherein the Carbon nanotube assembly comprises vertically aligned carbon nanotubes, where the free ends of the Carbon nanotube assembly are connected via the active brazing alloy on the substrate.

14. Active brazing alloy for joining a Carbon Nanotube-assembly on a substrate, wherein
the active brazing alloy comprises
at least a ternary alloy with an amount of at least 20 wt. % copper and at least one carbide forming element with an amount of at least 0.5 wt. %, with particle sizes of below 50 μm mixed with an organic binder.

15. Active brazing alloy (3, 3′) for joining a Carbon Nanotube-assembly on a substrate according to claim 14, wherein the organic binder is a cellulose nitrate binder.

16. Active brazing alloy for joining a Carbon Nanotube-assembly on a substrate according to claim 15, wherein the active brazing alloy comprises
between 70-75 wt. % copper,
between 10-15 wt. % tin,
between 5-18 wt. % titanium and
between 0.1-2 wt. % zirconium
in form of a metal alloy powder.

17. Active brazing alloy for joining a Carbon Nanotube-assembly on a substrate according to claim 15, wherein the active brazing alloy comprises
between 50-70 wt. % silver,
between 20-40 wt. % copper and
between 0.5-2 wt. % titanium,
between 0-25 wt. % indium
in form of a metal alloy powder.

18. Method for joining a Carbon Nanotube-assembly on a substrate, the method comprising:
providing an active brazing alloy in form of an at least ternary alloy, comprising an amount of copper and at least one carbide forming element with an amount of at least 1 wt. % having a solidus temperature above 770° C., and
active brazing between 800° C. and 900° C.

19. Device comprising a Carbon nanotube assembly fixed to a substrate, wherein the Carbon nanotube assembly/substrate joint is carried out by the joining method according to claim 1, whereas the used active brazing alloy is incomplete melted, the joint formation shows a TiC interphase and the re-melting temperature is about 770° C. or higher.

20. Device according to claim 19, wherein the device is a cold electron source, in particular a carbon nanotube-based cathode for an X-ray source or the device is at least part of a wear resistant sliding contact.
